(19) United States
(12) Patent Application Publication
(10) Pub. No.: US 2005/0086388 A1
(43) Pub. Date: Apr. 21, 2005

(54) Method for global interconnection of telecommunications services

(76) Inventors: Michael James Boyle, Everett, WA (US); Kyle Peters, Seattle, WA (US); Matt Alan Ruehlen, Seattle, WA (US)

Correspondence Address: GARRISON ASSOCIATES, 2001 SIXTH AVENUE, SUITE 3300, SEATTLE, WA, 981212522, US

(21) Appl. No.: 10/940,833

(22) Filed: Sep. 13, 2004

Related U.S. Application Data
(60) Provisional application No. 60/502,356, filed on Sep. 11, 2003.

(51) Int. Cl. G06F 15/16

(52) U.S. Cl. 709/249; 709/201

(57) ABSTRACT

The current document discloses a method of communication that is accomplished by providing a room with connections to high bandwidth networks, and connections to other communication networks as well. The invention disclosed herein is a communication portal having connections to a plurality of communication networks. The communication portal is a physical location that can be accessed by business entities and individuals who need to communicate or conduct other business that requires large amounts of bandwidth. An individual or entity can use the room to communicate with branch offices or other individuals in other cities. All parties to such communications can use similar facilities located in the city where the participant resides or, less than all participants can use such facilities.

### CROSS-REFERENCE TO RELATED APPLICATION

This application claims priority from U.S. Provisional Patent Application Ser. No. 60/502356, filed on Sep. 11, 2003 and entitled GLOBAL INTERCONNECTION OF TELECOMMUNICATIONS SERVICES.

### FIELD OF THE INVENTION

This invention relates to multimedia conferencing via the public switched telephone network (the PSTN), the Internet, and other data networks.

### BACKGROUND OF THE INVENTION

As the economy becomes increasingly global, more and more companies have offices in multiple countries. Additionally, companies that do not have offices in multiple countries often do business with companies in numerous other countries. In order to communicate with each other, companies often have to install expensive infrastructure. The expense of such communication infrastructure can be prohibitive for many companies and therefore can affect the effectiveness of a company.

### BRIEF SUMMARY OF THE INVENTION

The current document discloses a method of communication that takes advantage of the fact that cities around the world are starting to install fiber optic networks and other infrastructure that support communication applications requiring relatively large amounts of band width. The invention disclosed herein is a communication portal having connections to a plurality of communication networks. The communication portal is a physical location that can be accessed by business entities and individuals who need to communicate or conduct other business that requires large amounts of bandwidth.

Essentially this is accomplished by providing a room with connections to high bandwidth networks, and connections to other communication networks as well. An individual or entity can use the room to communicate with branch offices or other individuals in other cities. All parties to such communications can use similar facilities located in the city where the participant resides or, less than all participants can use such facilities.

### DETAILED DESCRIPTION OF THE INVENTION

The purpose of this document is described the general concepts of a Global Meet-Me Room, abbreviated GMMR for the purpose of the patent application. It is not our intent to fully describe all activities that would take place in the GMMR or the physical dimensions of the GMMR but rather to layout the general framework for what a GMMR would look like and the types of activities that would occur around it.

It is the general feeling of the Sixth & Virginia Properties/the Westin Building management that the concepts of activities surrounding the advent of the GMMR could very likely have a profound impact on the telecommunications and information technology sectors of the economy and therefore that it is in interest of the Westin Building management to securities concepts and trademark names for potential economic gain as well as for posterity.

The GMMR is a new method of providing telecommunications services to tenants in office buildings. Such services are traditionally provided through the use of an implementation unique to each and every customer. Currently, service providers must physically extend their networks to each tenant when a new service is requested and tenants must obtain equipment that interfaces with the type of network the providers have available in the area. This causes delays in, and increases the complexity and cost of, implementations.

The GMMR solves these problems by creating a standard interface for services, creating a standard means of and process for connecting to the services, and creating a standard environment for providers to base their service provisioning from.

In general, the physical location and description of a GMMR would be as follows:
Global Meet-Me Room's will be located in buildings that maintain high bandwidth connectivity with two or more network service providers (a network service provider is a company that provides any combination of voice, data or media services through which a network is able to be established.) GMMR's are ideally suited to the class of building known as carrier hotels or telecommunication hubs.
GMMR=s will consist of a secure room with one or more separate, locking cabinets. Each cabinet must have the capability to mount telecommunications switching and routing equipment.
GMMR=s will have card key access and CCTV monitoring systems installed.
GMMR=s will be furnished with sufficient HVAC & UPS/Generator backed power.
GMMR=s operators will supply fiber, CAT5 and cable management panels sufficient to accommodate the potential tenants of the GMMR.
GMMR's will consist of tenant-supplied switches to accommodate either Ethernet or IP networks. These devices in a 2U format typically have 48 ports however changes in technology and increase of module-based equipment could accommodate future bandwidth growth and demand as well as changes in delivery methods.
GMMR=s is will include simple labeling procedures to identify network service providers, application service providers, and customer cable runs including the cities served
GMMR=s will provide Ethernet and IP access to tenants of the facilities they are located in. They will include standard, facilities based pricing that will accommodate both in building cabling structures and monthly port charges.

Currently for a company to setup communications between its offices, they would have to:
determine overall bandwidth requirements
determine equipment requirements and cost
determine separate voice and data vendors
solicit bides and review contracts
potential waiting period for installation 6 weeks to 6 months
set it up and test run, work out all the kinks

Often after a company has set up data communication, they will start developing additional needs (VOIP, streaming video, etc.) After the new needs have been identified, the process will have to be repeated. There is a strong likelihood of additional delays.

With GMMR in place a company can establish communication with its branch office via local carriers and then choose a vendor within GMMR to setup an Ethernet or IP connection to the local GMMR.

If the company wants to establish a new way of communication (Video Services) or additional services, it does not need to establish additional connections, the company can simply increase their bandwidth to the local GMMR for the new applications.

With GMMR, there are new opportunities and venues that could be offered through Application Service Providers (ASPs) including: Secure Messaging, External Storage (NAS, SAN), Firewalls, Database Hosting, Outsourced Backup and other applications that are on the horizon.

1. A method for interconnecting communications networks comprising the steps of:
providing a secured communication portal located in buildings that maintain high bandwidth connectivity with two or more network service providers;
providing users of the communication portal with access devices such that they can gain access to the communication portal;
providing the communication portal with sufficient HVAC;
providing the communication portal with sufficient UPS;
providing the communication portal with sufficient backup power sources;
providing sufficient fiber, CAT5 and cable management panels to accommodate the potential users needs; and
providing access to a plurality of communication networks via the communication portal.
